(19) United States
(12) Patent Application Publication
(10) Pub. No.: US 2010/0157334 A1
(43) Pub. Date: Jun. 24, 2010

(54) IMAGE PROCESSING APPARATUS, IMAGE PROCESSING SYSTEM, IMAGE PROCESSING METHOD, AND MEDIUM STORING PROGRAM

(75) Inventor: Masaaki Oobayashi, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/627,831

(22) Filed: Nov. 30, 2009

(30) Foreign Application Priority Data
Dec. 24, 2008 (JP) 2008-328656

(51) Int. Cl. G06F 15/00

(52) U.S. Cl. 358/1.9

(57) ABSTRACT

A plurality of types of images corrected based on lookup tables set in advance in association with a plurality of types of light sources are printed as a chart displayed in association with a plurality of types of light sources. Evaluations by the user under viewing light sources corresponding to the plurality of types of images in the outputted chart are quantified. Evaluation values of the plurality of types of light sources are calculated. The calculated evaluation values are used to specify a light source from the plurality of types of light sources. Image data is corrected based on a lookup table corresponding to the specified light source.

### BACKGROUND OF THE INVENTION

1. Field of the Invention

The present invention relates to an image processing apparatus, an image processing system, an image processing method, and a medium storing a program for correcting image data.

2. Description of the Related Art

The appearance of an image outputted from a printer significantly varies depending on the light source for observation. Therefore, when the light source for observation changes, the outputted image may look like an unfavorable image. For example, when an image that looks favorable under a bluish white light source such as a daylight fluorescent lamp is printed and outputted, the entire image may look reddish and unfavorable if the outputted image is observed under a red light source such as a light bulb.

To solve such a problem, a light source for observing a print output material needs to be acquired in advance, and a color management process suitable for the light source needs to be executed. For example, Japanese Patent Laid-Open No. 2000-050086 describes a method of performing color management suitable for a viewing light source.

However, in the case of Japanese Patent Laid-Open No. 2000-050086, since the user inputs viewing light source information, knowledge of the light source is required. Although the measurement of the viewing light source may be performed, a device for measuring the viewing light source is required in that case.

Meanwhile, a color processing method for simply estimating the viewing light source is also considered, in which images applied with light source corrections corresponding to a plurality of different light sources are arranged and outputted in a predetermined layout, the output materials are visually observed under the viewing light sources, and the user selects a favorable image.

However, since the user visually selects a chart image, it may be difficult for the user to uniquely select, without doubt, an image based on optimal light source correction.

For example, under the viewing light source, if a light source correction image A corresponding to a light source 1 and another light source correction image B corresponding to a light source 2 are determined to look favorable, the user cannot determine which light source to choose. Therefore, the light source needs to be appropriately estimated without doubt for selecting the light source.

### SUMMARY OF THE INVENTION

The present invention provides an image processing apparatus, an image processing method, and a medium storing a program capable of easily performing appropriate light source estimation.

The present invention in its first aspect provides an image processing apparatus that corrects image data for printing images, the image processing apparatus comprising: a specifying unit configured to specify, based on evaluations by a user under a viewing light source for a plurality of images applied with correction processes corresponding to a plurality of types of light sources, the viewing light source from the plurality of types of light sources; and a correcting unit configured to correct the image data by the correction process corresponding to the viewing light source specified by the specifying unit.

The present invention in its second aspect provides an image processing system that corrects image data for printing images, the image processing system comprising: a printing unit configured to print a plurality of images applied with correction processes corresponding to a plurality of types of light sources; a specifying unit configured to specify, based on evaluations by a user under a viewing light source for the plurality of images printed by the printing unit, the viewing light source from the plurality of types of light sources; and a correcting unit configured to correct the image data by the correction process corresponding to the viewing light source specified by the specifying unit.

The present invention in its third aspect provides an image processing method for correcting image data for printing images, the image processing method comprising: a printing step of printing a plurality of images applied with correction processes corresponding to a plurality of types of light sources; a specifying step of specifying, based on evaluations by a user under a viewing light source for the plurality of images printed in the printing step, the viewing light source from the plurality of types of light sources; and a correction step of correcting the image data by the correction process corresponding to the viewing light source specified in the specifying step.

The present invention in its fourth aspect provides a computer-readable medium storing an image processing program causing a computer to execute functions of: printing a plurality of images applied with correction processes corresponding to a plurality of types of light sources; specifying, based on evaluations by a user under a viewing light source for the plurality of images in the printing, the viewing light source from the plurality of types of light sources; and correcting the image data by the correction process corresponding to the viewing light source specified in the specifying.

According to the present invention, appropriate light source estimation can be easily performed.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an image processing apparatus according to a first embodiment of the present invention;

FIG. 2 is a flow chart showing a procedure of a correction process executed by the image processing apparatus;

FIG. 3 is a diagram showing an example of a setting screen of a viewing light source;

FIG. 4 is a diagram showing an example of a chart image held in an image holding unit;

FIG. 5 is a diagram showing the correspondence between light sources and light source correction parameters;

FIG. 6 is a flow chart showing a procedure of a specific process of a light source correction parameter setting unit shown in step S2;

FIG. 7 is a diagram showing an example of viewing light source information;

FIG. 8 is a diagram showing a calculation example of viewing light source evaluation values;

FIG. 9 is a diagram for explaining the relationship between a representative color of a light source correction image and an area in which the representative color looks favorable under the viewing light source;

FIG. 10 is a flow chart showing a procedure of a specific process of a light source correcting unit shown in step S4;

FIG. 11 is a diagram showing an example of color gamut data of an output device;

FIG. 12 is a block diagram showing a hardware configuration of the image processing apparatus according to a second embodiment;

FIG. 13 is a flow chart showing a procedure of a correction process executed by the image processing apparatus according to the present embodiment;

FIG. 14 is a diagram showing an example of a setting screen of a viewing light source according to the present embodiment; and

FIG. 15 is a diagram showing another example of the viewing light source information held in a viewing light source information holding unit.

### DESCRIPTION OF THE EMBODIMENTS

Preferred embodiments for implementing the present invention will now be described in detail with reference to the drawings. The same constituent elements are designated with the same reference numerals, and the description will not be repeated.

### First Embodiment

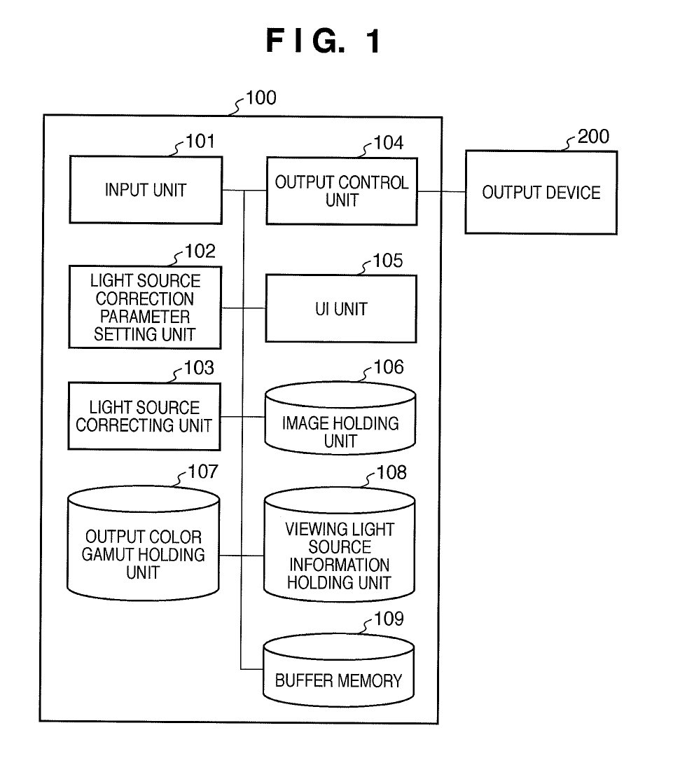

FIG. 1 is a block diagram showing a hardware configuration of an image processing apparatus according to the present invention. In FIG. 1, reference numeral 100 denotes an image processing apparatus. An input unit 101 inputs image data, and a light source correction parameter setting unit 102 sets light source correction parameters based on an instruction of light source correction inputted by the user.

A light source correcting unit 103 applies light source corrections to input images (original images) based on the set light source correction parameters, and an output control unit 104 outputs image data to an image output device such as a printer. A UI unit 105 is a user interface for the user to input an instruction of image data or light source corrections.

An image holding unit 106 is a non-volatile memory such as a hard disk and holds chart images for estimating the viewing light source. An output color gamut holding unit 107 is also a non-volatile memory and holds a color gamut (color reproduction range) of an output device 200.

A viewing light source information holding unit 108 is also a non-volatile memory and holds viewing light source information described below. A buffer memory 109 is a buffer memory such as a RAM that temporarily stores a calculation result in the middle of processing.

An output device 200 is an output device such as a color printer and is connected to the image processing apparatus 100 through, for example, a USB (Universal Serial Bus) or IEEE 1394 serial bus interface. The output device 200 comprises a printing unit that prints charts.

In FIG. 1, a CPU not shown controls the components, from the input unit 101 to the buffer memory 109.

<Operation in Image Processing Apparatus 100>

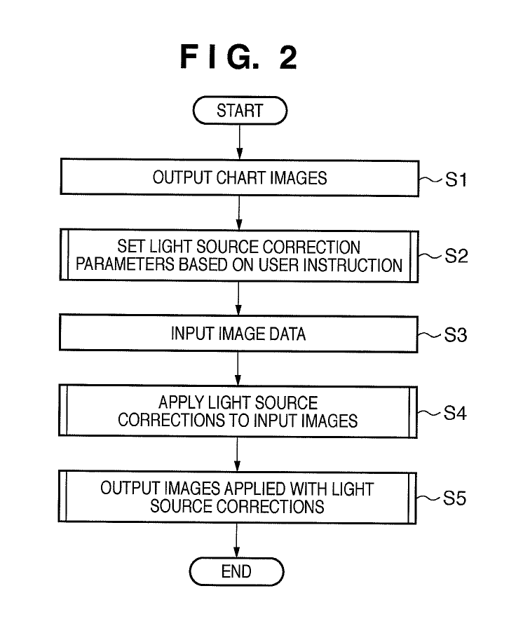

FIG. 2 is a flow chart showing a procedure of an illustrative correction process executed by the image processing apparatus 100. The CPU of the image processing apparatus 100 controls and executes the processes of the steps shown in the flow chart of FIG. 2.

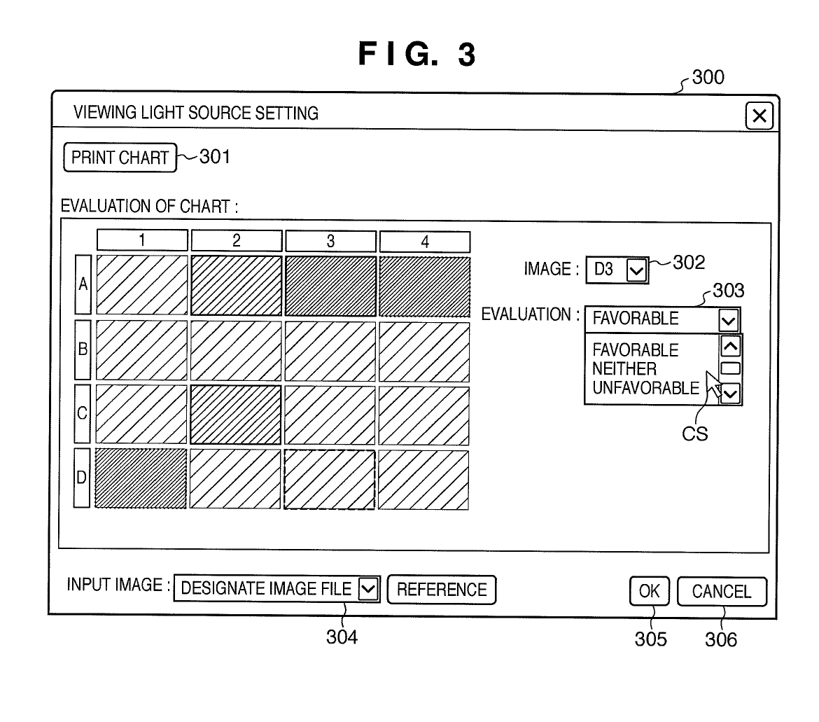

In step S1, the output control unit 104 detects, through the UI unit 105, pressing of a chart printing button 301 by the user on a setting screen 300 of viewing light sources illustrated in FIG. 3. In accordance with the detection of pressing, the output control unit 104 outputs the chart images held in the image holding unit 106 to the output device 200, and the printing unit prints the chart images.

The chart images used in the present embodiment will now be described.

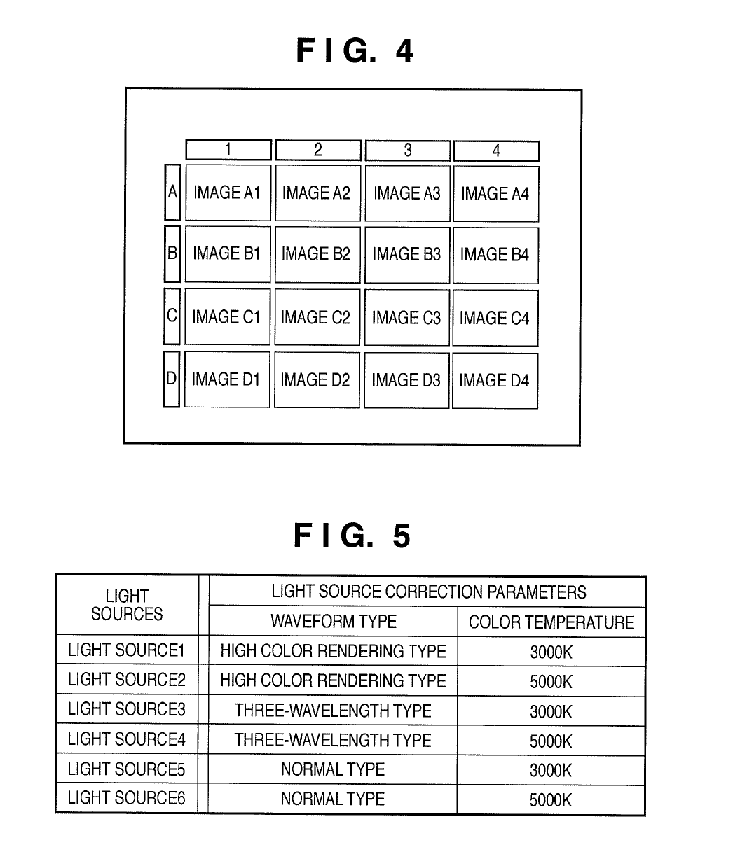

FIG. 4 shows an example of the chart images held in the image holding unit 106. The chart images in the present embodiment are images in which light source corrections corresponding to a plurality of different light sources are applied to four natural images (hereinafter, “basic images”) with different colors, and the chart images are arranged in a predetermined layout. For example, in FIG. 4, light source corrections corresponding to four of the six types of light sources are applied.

The basic images may be natural images having an important color (representative color), such as a flesh color, generally called a memory color to facilitate the determination of the favorability as compared to simple color charts. Since the change in the appearance due to the light source differs according to the color. A plurality of different memory colors may be combined in the chart images. As for the layout, to facilitate the user to determine the favorability of a plurality of natural images applied with the light source corrections. The images may be vertically or horizontally arranged for each basic image. The favorability can be easily compared by arranging the same types of images in a line.

The chart images are attached with numbers for each light source correction image. In the example of FIG. 4, row numbers 1 to 4 corresponding to the types of light source corrections and column numbers A to D corresponding to the basic images are attached. The light source correction parameters in the present embodiment include, for example, the color temperature of light sources and the waveform type of spectral distribution (high color rendering type, three-wavelength type, and normal type).

FIG. 5 shows a correspondence table between light source numbers of six types of light sources and light source correction parameters in the present embodiment. In the present embodiment, the light source correction images in the chart images are images in which four types of light source corrections among the six types of light sources are applied to the basic images.

In step S2, the light source correction parameter setting unit 102 detects a number and an evaluation value input by the user through a chart number input unit 302 and an evaluation input unit 303 of the setting screen 300 and holds the detected number and evaluation value in the buffer memory 109.

At this point, the user observes the chart images (printed material) outputted by the output device 200 in step S1 under the viewing light source of the user (under the light source for observing the output images). The number of the light source correction image is inputted to the chart number input unit 302, and the degree of favorability of the selected light source correction image is inputted to the evaluation input unit 303 as an evaluation value through the UI unit 105.

When pressing of an OK button 305 is detected, the light source correction parameter setting unit 102 specifies a light source from the number and the evaluation value of the light source correction image held in the buffer memory 109 and the viewing light source information held in the viewing light source information holding unit 108. Light source correction parameters corresponding to the specified light source are also determined. The determined light source correction parameters are set to the light source correcting unit 103. A specific process of the light source correction parameter setting unit 102 will be described below.

In step S3, the input unit 101 acquires an input image file inputted to an input image file name input unit 304 through the UI unit 105 and stores image data of the input image file in the buffer memory 109.

In step S4, the light source correcting unit 103 applies light source corrections based on the light source correction parameters determined in step S2 to the image data of the input image file stored in the buffer memory 109. A specific process of the light source correcting unit 103 will be described below.

In step S5, the output control unit 104 outputs the images applied with the light source corrections in step S4 to the output device 200.

<Operation of Light Source Correction Parameter Setting Unit 102>

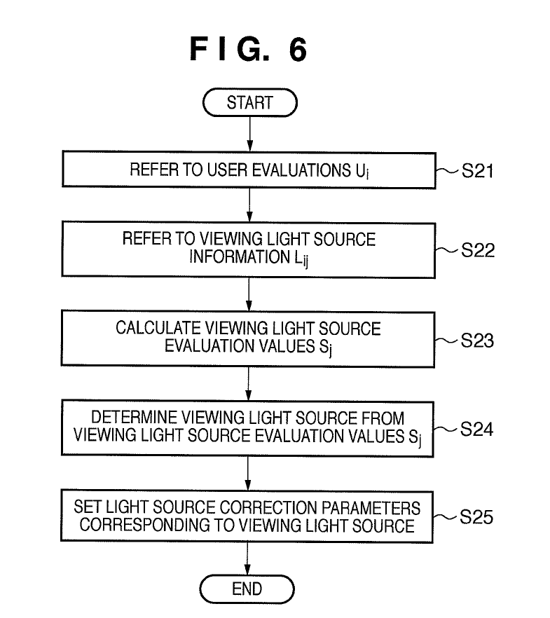

FIG. 6 shows a flow of a specific process of the light source correction parameter setting unit 102 in step S2.

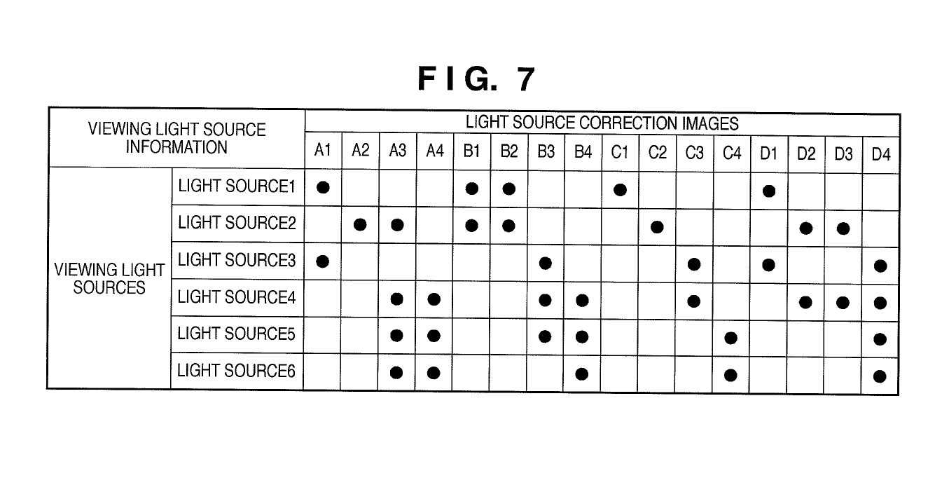

In the present embodiment, viewing light source evaluation values are calculated for a plurality of different viewing light sources shown in FIG. 7. Among the sources, the viewing light source with the maximum viewing light source evaluation value is specified as the current viewing light source of the user. Details of the process will now be described.

In step S21, the numbers and the evaluation values of the light source correction images held in the buffer memory 109 are referenced. The numbers (A1 to D4) of the images applied with the light source corrections will be referred to as i, and the user evaluation values will be referred to as Ui. The values Ui are values quantified in response to the values designated by the chart number input unit 302 and the evaluation input unit 303. In the present embodiment, the user evaluation values Ui have one of the values of favorable “1”, neither “0”, and unfavorable “−1”.

In step S22, the viewing light source information (FIG. 7) related to the favorability of the light source correction images with respect to the viewing light sources is referenced from the viewing light source information holding unit 108. The light source numbers (light sources 1 to 6) of the viewing light sources will be referred to as j, and the viewing light source information will be referred to as Lij.

The viewing light source information Lij in the present embodiment has one of two values: the representative color of the light source correction images under the viewing light source looks favorable “1” or unfavorable “0”.

FIG. 7 shows an example of the viewing light source information. Black circles are put when the representative color of the light source correction images looks favorable “1” under the viewing light sources, and no mark is put when the color looks unfavorable “0”. Details of the viewing light source information shown in FIG. 7 will be described below.

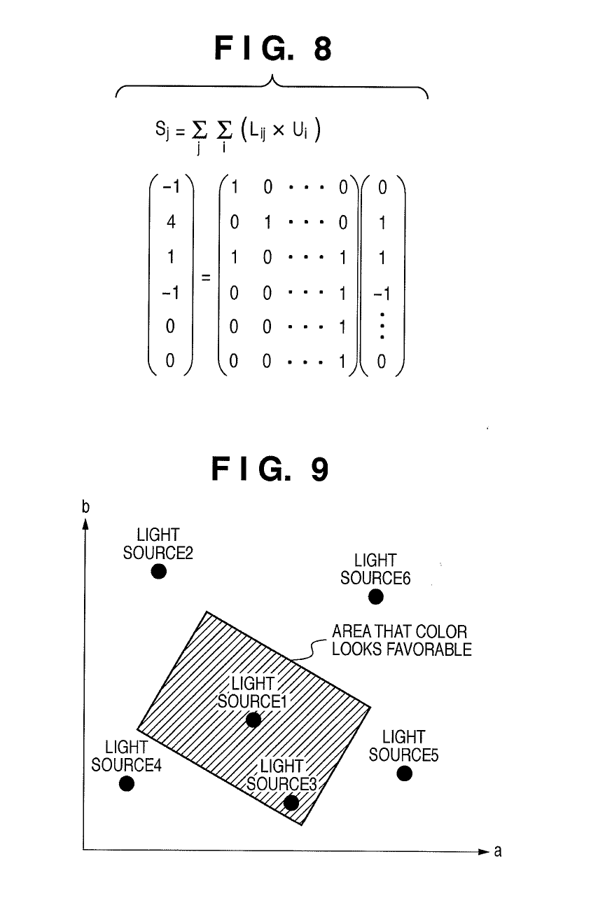

In step S23, viewing light source evaluation values, indicating the likelihood in the viewing light sources, are calculated from the user evaluation values Ui and the viewing light source information Lij. The viewing light source evaluation values will be referred to as Sj. The viewing light source evaluation values Sj are calculated using a calculation formula shown at the upper part of FIG. 8.

FIG. 8 is a diagram showing a calculation example of the viewing light source evaluation values Sj. The viewing light source evaluation values Sj include a six-row one-column matrix, the viewing light source information Lij includes a six-row sixteen-column matrix, and the user evaluation Ui includes a sixteen-row one-column matrix. The calculation formula is expressed by a determinant.

In step S24, the viewing light source of the user is determined from the viewing light source evaluation values Sj. In the present embodiment, among the viewing light source evaluation values Sj, the viewing light source with the maximum viewing light source evaluation value is specified as the current viewing light source of the user. If there are a plurality of maximum viewing light source evaluation values, one light source may be automatically selected by, for example, using the light source numbers.

In step S25, light source correction parameters corresponding to the specified viewing light source are set to the light source correcting unit 103.

In the present embodiment, the user first refers to the printed chart images to select the favorability of the light source correction images on the setting screen 300. Therefore, the selection is intuitively made in a procedure of comparing the actual images. In addition to such user input, the current viewing light source of the user is estimated based on predetermined viewing light source information. Therefore, the user can subjectively select the light source without doubt and can perform appropriate light source estimation.

<Details of Viewing Light Source Information>

The viewing light source information shown in FIG. 7 in the present embodiment is information showing the favorability under the viewing light sources for the representative colors of the light source correction images of the chart images. The viewing light source information holding unit 108 holds the viewing light source information shown in FIG. 7. As shown in FIG. 7, the viewing light source information is shown in a table in which a plurality of types of basic images applied with four types of light source corrections and a plurality of types of viewing light sources are associated.

As already described, the viewing light source information Lij shown in FIG. 7 have values indicating whether the representative color of the light source correction images looks favorable “1” or unfavorable “0” under the viewing light sources.

The values of whether the color looks favorable or not shown in FIG. 7 will now be described.

FIG. 9 shows color values (color appearance values Jab) under six types of viewing light sources for the representative color of the light source correction image A1. The rectangular area in FIG. 9 shows an area in which the representative color of the light source correction image A1 looks favorable in a Jab space.

For example, when the representative color of the light source correction image A1 is observed under the light source 1, the representative color of the light source correction image A1 is in the area in which the color looks favorable. On the other hand, when the color is observed under the light source 2, the representative color of the light source correction image A1 is not in the area that the color looks favorable.

The information of whether the color values of the representative colors of the light source correction images are in the area that the color looks favorable under the viewing light sources are held in advance as viewing light source information. The other types of light source correction images are also determined in the same way.

In the present invention, a table is prepared as shown in FIG. 7, the table indicating, for example, how the images applied with four types of light source corrections for four types of colors look under six types of light sources.

The “favorability” that the user has inputted by looking at the chart printed under the actual viewing light source (so-called subjectivity of user) based on the viewing light source information as shown in FIG. 7 is added to ultimately specify the current viewing light source of the user and perform optimal light source correction.

<Operation of Light Source Correcting Unit 103>

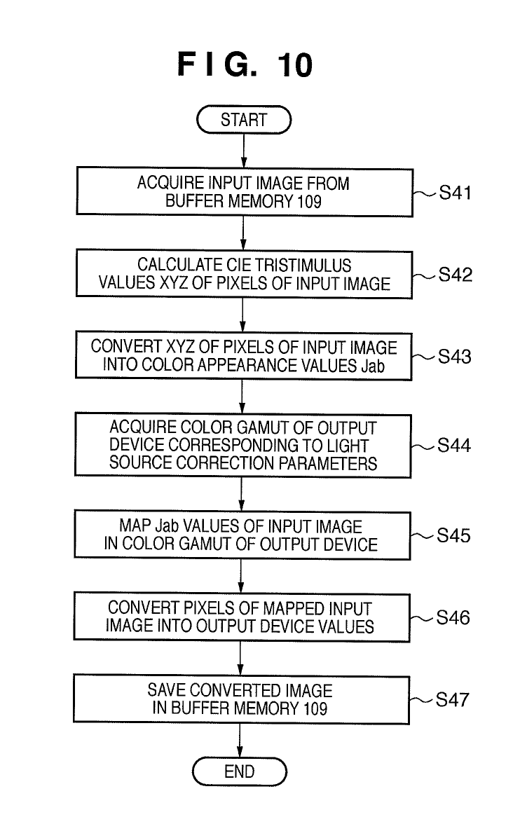

FIG. 10 is a flow chart showing a procedure of a specific process of the light source correcting unit 103 in step S4.

In step S41, image data of an input image is acquired from the buffer memory 109.

In step S42, CIE tristimulus values XYZ of the image data of the input image are calculated. In the description of the present embodiment, the bit count of the input image is 8 bits, and the color space representing the image is an sRGB color space that is an international standard color space. Expression 1 shows a formula for converting the sRGB color space into XYZ. The conversion expression shown in Expression 1 is used to convert the RGB values of the pixels of the input image into XYZ values.

$$\{ \begin{matrix}{R}^{′} = R / 255 \\ {G}^{′} = G / 255 \\ {B}^{′} = B / 255\end{matrix} \\ {R}^{′} , {G}^{′} , {B}^{′} \leq 0.04045 \{ \begin{matrix}{R}^{″} = {R}^{′} / 12.92 \\ {G}^{″} = {G}^{′} / 12.92 \\ {B}^{″} = {B}^{′} / 12.92\end{matrix} \\ {R}^{′} , {G}^{′} , {B}^{′} > 0.04045 \{ \begin{matrix}{R}^{″} = {[ \frac{( {R}^{′} + 0.055 )}{1.055} ]}^{2.4} \\ {G}^{″} = {[ \frac{( {G}^{′} + 0.055 )}{1.055} ]}^{2.4} \\ {B}^{″} = {[ \frac{( {B}^{′} + 0.055 )}{1.055} ]}^{2.4}\end{matrix} \\ ( \begin{matrix}X \\ Y \\ Z\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}{R}^{″} \\ {G}^{″} \\ {B}^{″}\end{matrix} ) \\ £1 If {R}^{′} , {G}^{′} , {B}^{′} \leq 0.04045 \\ £2 If {R}^{′} , {G}^{′} , {B}^{′} > 0.04045 \\ £3 Expression ( 1 ) \qquad ( 1 )$$

In step S43, the XYZ values of the pixels of the input image are converted into color appearance values. In the present embodiment, for example, a transformation model of color appearance model CIECAM02 standardized by CIE is used to convert the XYZ values of the pixels into the color appearance values Jab. Parameters of observation environment used in that case are compliant to the standard observation environment of sRGB.

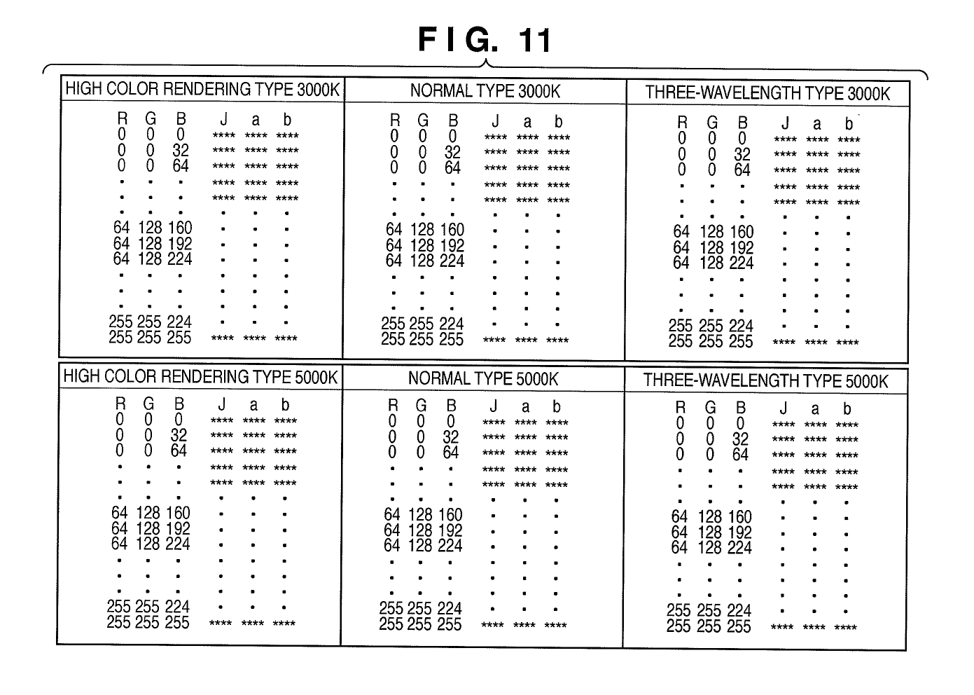

In step S44, the light source correcting unit 103 reads out color gamut data corresponding to the light source correction parameters corresponding to the specified light source from the output color gamut holding unit 107. FIG. 11 shows an example of color gamut data of the output device 200 held in the output color gamut holding unit 107. As shown in FIG. 11, the color gamut data corresponding to the light source correction parameters is stored in the output color gamut holding unit 107 in a form of a three-dimensional space lookup table.

Since the appearance of color differs depending on the light source for observation, the color gamut data of the output device 200 is prepared for each type of the light source as shown in FIG. 11. The color gamut data is stored in a form described with Jab values obtained when RGB data (729 colors) sliced by nine in the range of 0≦R, G, B≦255 is outputted by the output device 200.

The creation of color gamut data will now be described. The output device 200 first outputs in advance a patch corresponding to the RGB data sliced by nine. A colorimeter, etc., measures the color of the outputted patch, and the XYZ values are calculated from the obtained spectral reflectance and the spectral radiance of the light sources. Information of the observation environment parameters of the light sources, etc., is then used to convert the XYZ values into Jab values based on the color appearance model. The Jab values are associated with the RGB data to create the color gamut data as shown in FIG. 11.

The color gamut data created this way is held in association with the types of light sources. In the color gamut data, the device values (RGB) and the values corresponding to the color measurement (Jab values in the present embodiment) are associated. Therefore, in the present embodiment, it can be stated that the color gamut data indicates not only the color gamut of the output device, but also the color reproduction characteristics of the output device.

An output color gamut used in color gamut mapping is calculated by analyzing the read out color gamut data. An analysis method of reading out Jab values corresponding to RGB data, in which any of R, G, and B is 0, and creating a geometrical solid from the Jab values may be used. A method of creating a convex polyhedron including the Jab values stored in the read out color gamut data may also be used.

In step S45, the Jab values of the input image data converted in step S43 are mapped in the color gamut of the output device corresponding to the specified light source correction parameters. In the present embodiment, the output color gamut is mapped to favorably reproduce the memory color of human being. Various generally known methods can be used to favorably map the memory color.

In step S46, the mapped Jab values are converted into output device values (for example, device RGB values). Specifically, the correspondence relationship between the 729-color RGB data stored in the color gamut data and the Jab values is used to calculate the device RGB values corresponding to the mapped Jab values.

For example, a plurality of Jab values surrounding a target Jab value are detected, and interpolation calculation, such as cubic interpolation and tetrahedral interpolation, is used based on device RGB values corresponding to the Jab values to estimate device RGB values corresponding to the target Jab value.

In step S47, the converted device RGB values are stored in the buffer memory 109, and the process ends.

As described, the light source correcting unit 103 acquires the color gamut data corresponding to the light source correction parameters set in the light source correction parameter setting unit 102, and the acquired color gamut data is used to calculate the output device values. As a result, the color reproduction optimal for the current viewing light source of the user can be realized.

### Second Embodiment

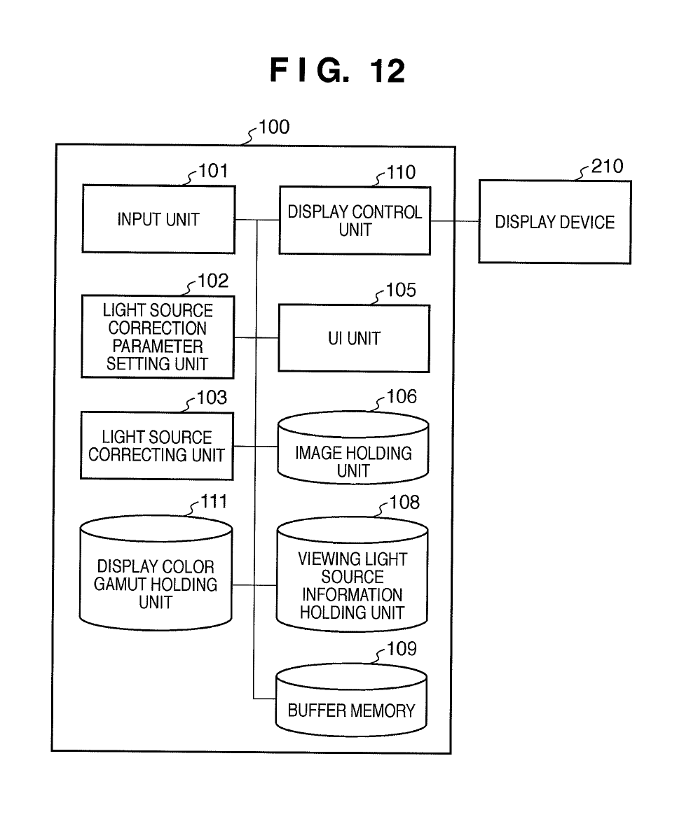

FIG. 12 is a block diagram showing a hardware configuration of the image processing apparatus according to the present embodiment. In FIG. 12, reference numerals 100 to 109 are the same as in the first embodiment. Reference numeral 110 is a display control unit that displays image data on an image display device such as a CRT and an LCD. Reference numeral 111 denotes a non-volatile memory which is a display device color gamut holding unit that holds a color gamut (color reproduction range) of a display device 210. Reference numeral 210 denotes a display device such as a CRT and an LCD and is connected to the image processing apparatus 100 through, for example, a serial bus interface such as D-sub and DVI.

<Operation in Image Processing Apparatus 100>

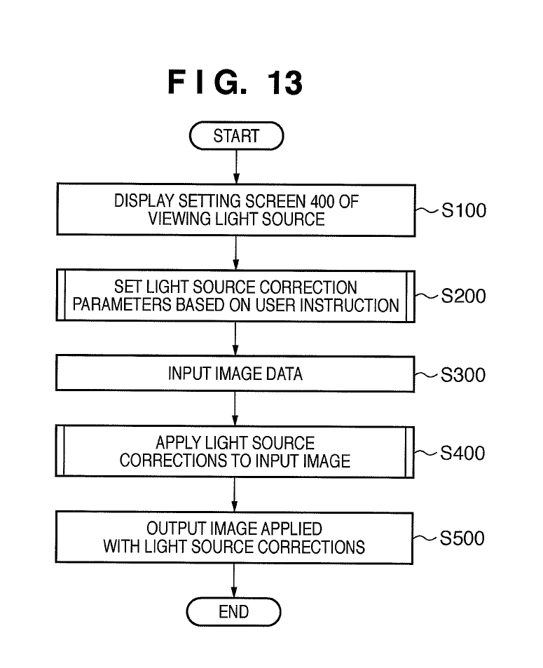

FIG. 13 is a flow chart of an illustrative process executed by the image processing apparatus 100.

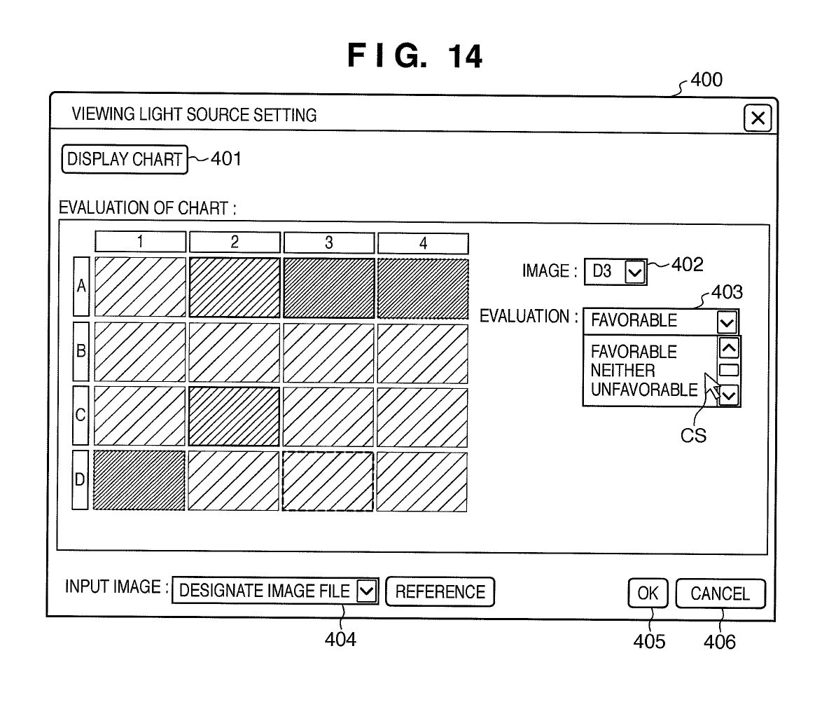

In step S100, the display control unit 110 detects pressing of a chart display button 401 by the user on a setting screen 400 of viewing light source illustrated in FIG. 14 through the UI unit 105. In accordance with the detection of pressing, the display control unit 110 displays the chart images held in the image holding unit 106 on the display device 210. The chart images held in the image holding unit 106 are light source correction images arranged in a predetermined layout as in FIG. 4.

In step S200, the light source correction parameter setting unit 102 detects a number and an evaluation value inputted by the user through a chart number input unit 402 and an evaluation input unit 403 on the setting screen 400 and holds the detected number and evaluation value in the buffer memory 109.

At this point, the user observes the chart images displayed by the display device 210 under the viewing light source of the user (under the light source for observing the displayed images). The user then inputs the number of light source correction image in the chart number input unit 402 and the degree of favorability of the selected light source correction image in the evaluation input unit 403 through the UI unit 105.

When pressing of an OK button 405 is detected, the light source correction parameter setting unit 102 specifies light source correction parameters from the number and the evaluation value of the light source correction image held in the buffer memory 109 and the viewing light source information held in the viewing light source information holding unit 108. The specified light source correction parameters are set to the light source correcting unit 103. Specific processes of the light source correction parameter setting unit 102 are the same as in the description of the first embodiment.

In this way, when the output device serves as the display device as shown in FIG. 12, the user can select the favorability of the light source correction images through the UI. Therefore, the selection can be intuitively made in a procedure of comparing the actual images. In addition to such user input, the current viewing light source of the user is estimated based on predetermined viewing light source information. Therefore, the user can subjectively select the light source without doubt and can perform appropriate light source estimation.

In step S300, the input unit 101 acquires an input image file inputted to an input image file name input unit 404 through the UI unit 105 and saves image data stored in the input image file in the buffer memory 109.

In step S400, the light source correcting unit 103 applies light source corrections based on the light source correction parameters set in step S200 to the image data of input images stored in the buffer memory 109.

Specific processes of the light source correcting unit 103 are the same as in the description of the first embodiment. In the present embodiment, the light source correcting unit 103 acquires color gamut data from the display device color gamut holding unit 111 and uses the color gamut data to calculate display device values corresponding to the light source correction parameters set in the light source correction parameter setting unit 102. As a result, the color reproduction in accordance with the viewing light source can be realized.

In step S500, the display control unit 110 displays the images applied with the light source corrections in step S400 on the display device 210.

### Modified Examples

In the embodiments, although the chart images are held in advance in the image holding unit 106, the images may be input from outside using a user interface. Basic images may be held, and a plurality of types of light source corrections may be applied to the held basic images to create chart images.

In the first embodiment, although the chart images are held in advance in the image holding unit 106 and are output using the output device 200, the chart images outputted in advance may be provided to the user.

In the embodiments, although images, in which four types of light source corrections are applied to four types of basic images, are arranged as shown in FIG. 4, other arrangements may also be used. In the embodiments, although four types of basic images are used for the chart images, the types of basic images are not limited to four types, but may be, for example, three or five types.

In the embodiments, although images, in which light source corrections corresponding to four types of light sources among six different types of light sources are applied, are formed into charts, the light sources are not particularly limited to six types. For example, there may be four, five, or ten types of light sources. In that case, the number of correspondence tables shown in FIG. 5 is changed in accordance with the number of types.

In the embodiments, although four types of basic images, in which light source corrections corresponding to four types of light sources among six different types of light sources are applied, are formed into charts, any light source correction image among the combinations of six types of light sources and four types of basic images may be formed into a chart. Thus, as for four of the six types of light sources, the light source corrections do not always have to be applied to four types of basic images with the same four types of light sources. In that case, in accordance with the number of light source correction images, the number of light source correction images of the viewing light source information shown in FIG. 7 also changes.

In the present embodiment, there are three levels, favorable, neither, and unfavorable, for the user evaluation of the light source correction images. However, the user evaluation may have two levels, favorable and unfavorable, or five levels, favorable, little favorable, neither, little unfavorable, and unfavorable. In that case, the held value is changed to a plurality of values in accordance with the number of levels of the user evaluation.

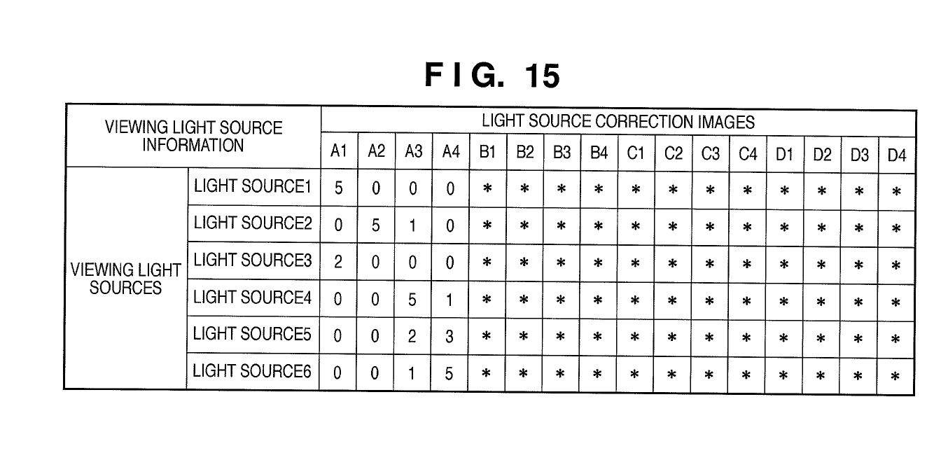

In the embodiments, although the viewing light source information is expressed by two values, favorable and unfavorable, the degrees of favorability of the light source correction images under the viewing light sources may be held as information of multiple values as shown in FIG. 15. The parts corresponding to light source correction images B1 to D4 shown in FIG. 15 may also hold information of multiple values in the same way.

In the determination method of the viewing light source in step S24 of the embodiments, the light source corresponding to the maximum evaluation value among the viewing light source evaluation values Sj is determined as the current viewing light source of the user. However, a method of interpolating light source correction parameters in highest two or more light sources among the viewing light source evaluation values Sj may be applied. For example, if the evaluation values of the light sources 1 and 2 shown in FIG. 7 are maximum, the light source correction parameters may be set by determining that the waveform type of the viewing light source is high color rendering type and that the color temperature is 4000K.

In the embodiments, although the bit count of the input images is 8 bits in the description of the processes, the input images are not limited to 8 bits, but may also be 12 bits or 16 bits.

In the embodiments, although the color space representing the input images is assumed to be an sRGB color space in the processes, the color space is not particularly limited to the sRGB color space, and any color space may be used. For example, the color space may be an Adobe RGB space or an sYCC space, or may be a color space dependent on the input device.

In the embodiments, although the output device color gamut is formed by the color appearance values Jab of data with RGB nine slices, the number of slices is not particularly limited to nine, and the number of slices may be set to the extent that the color gamut of the output device can be recognized. For example, the number of slices may be reduced to five or seven to reduce the calculations, may be increased to 12 or 17 to improve the accuracy, or may be set depending on the application.

In the embodiments, although a CIECAM02 space is used as the color appearance space, the space is not particularly limited to the CIECAM02 space, but any color appearance space may be used as long as the color appearance space corresponds to the light source correction. For example, a color appearance space, such as CIELAB and CIECAM97s standardized by CIE, may be used.

In the embodiments, the color gamut data holds the correspondence relationship between the device values (RGB) and the color appearance values (Jab) independent of the light sources. However, the color gamut data may hold correspondence relationship between the device values and color values that are dependent on the light source and independent of the device.

For example, the correspondence relationship between the device values and the XYZ values may be held. When the color values that are dependent on the light source and independent of the device are used, an inverse transformation model of the color appearance model is used for the Jab values mapped in step S45 to convert the Jab values into the XYZ values. The correspondence relationship stored in the color gamut data is then used to convert the mapped XYZ values into the device values. The parameters of the observation environment used in the inverse transformation model are values corresponding to the light source correction parameters set in step S2.

The present invention may be applied to a system constituted by a plurality of devices (such as a host computer, an interface device, a reader, and a printer) or to an apparatus constituted by one device (such as a copier and a facsimile machine). In the embodiments, although the image processing apparatus is an apparatus separate from the output apparatus, the image processing apparatus may be an output apparatus (printing apparatus) including a printing unit.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-328656, filed Dec. 24, 2008, which is hereby incorporated by reference herein in its entirety.

What is claimed is:

1. An image processing apparatus that corrects image data for printing images, the image processing apparatus comprising:
a specifying unit configured to specify, based on evaluations by a user under a viewing light source for a plurality of images applied with correction processes corresponding to a plurality of types of light sources, the viewing light source from the plurality of types of light sources; and
a correcting unit configured to correct the image data by the correction process corresponding to the viewing light source specified by the specifying unit.

2. The image processing apparatus according to claim 1, wherein
at least one of a color temperature of light source and a waveform type of spectral distribution is different in the plurality of types of light sources.

3. The image processing apparatus according to claim 1, wherein
the specifying unit specifies the viewing light source based on evaluations by the user performed in a plurality of levels for the plurality of images.

4. The image processing apparatus according to claim 1, wherein
the image processing apparatus is a printing apparatus comprising a printing unit that prints the plurality of images.

5. An image processing system that corrects image data for printing images, the image processing system comprising:
a printing unit configured to print a plurality of images applied with correction processes corresponding to a plurality of types of light sources;
a specifying unit configured to specify, based on evaluations by a user under a viewing light source for the plurality of images printed by the printing unit, the viewing light source from the plurality of types of light sources; and
a correcting unit configured to correct the image data by the correction process corresponding to the viewing light source specified by the specifying unit.

6. An image processing method for correcting image data for printing images, the image processing method comprising:
a printing step of printing a plurality of images applied with correction processes corresponding to a plurality of types of light sources;
a specifying step of specifying, based on evaluations by a user under a viewing light source for the plurality of images printed in the printing step, the viewing light source from the plurality of types of light sources; and
a correction step of correcting the image data by the correction process corresponding to the viewing light source specified in the specifying step.

7. A computer-readable medium storing an image processing program causing a computer to execute functions of:
printing a plurality of images applied with correction processes corresponding to a plurality of types of light sources;
specifying, based on evaluations by a user under a viewing light source for the plurality of images in the printing, the viewing light source from the plurality of types of light sources; and
correcting the image data by the correction process corresponding to the viewing light source specified in the specifying.
